(19) United States
(12) Patent Application Publication
(10) Pub. No.: US 2006/0144285 A1
(43) Pub. Date: Jul. 6, 2006

(54) Fluorine-containing coatings

(75) Inventors: Haridasan K. Nair, Williamsville, NY (US); Rajiv R. Singh, Getzville, NY (US); George A. Shia, Amherst, NY (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International, Inc., Morristown, NJ (US)

(21) Appl. No.: 11/026,977

(22) Filed: Dec. 30, 2004

(51) Int. Cl. C04B 9/02

(52) U.S. Cl. 106/14.31

(57) ABSTRACT

The present invention provides an ink for recordable media comprising a coating moiety and at least one fluorinated alcohol solvent for said at least one coating moiety, the fluorinated alcohol solvent preferably having a surface tension of not greater than about 27 dynes/cm. In certain preferred embodiments the fluorinated alcohol has the structure R_{f}—OH, wherein R_{f} is selected from the group consisting of H—[CX₂]ₙ—; Z-[CX₂—CX₂]ₙ—; Z-[CZX—CX₂]ₙ—; Z-[CZX—CZX]ₙ—; CZ₂CH—; Z-[CX═CX]ₙ—; Z-[CZ═CX]ₙ; Z-[CZ═CZ]ₙ—; Z-[CX₂]ₙ—; CX₂═CX—[CX₂]ₙ—; and Z-CZX—CX(CZX₂)—, wherein Z is independently —CF₃, —CHF₂, —CH₂F; —R—CF₃, —R—CHF₂, or —R—CH₂F, wherein R is a substituted or unsubstituted C₁-C₁₂ alkyl radical, or a substituted or unsubstituted fluorinated C₁-C₁₂ alkyl radical; X is independently hydrogen, Cl, Br, F, I, or Z; and n is an integer from 1 to 20.

### FIELD OF THE INVENTION

The present invention relates to coating compositions and to methods of applying coatings, and in particular embodiments to coating compositions and methods for use in the production of optical recording media such as, for example, digital video disks (DVDs) and the like.

### BACKGROUND OF THE INVENTION

In a solution coating process, a layer of material is applied to a surface from a solution (coating solution) comprising the material to be applied to the surface (coating moiety). Generally, the coating solution consists of a coating moiety and one or more volatile components (volatiles) which are not intended to remain on the surface being coated after the coating composition is dried. The volatiles generally comprise a solvent (liquid carrier) such as, for example, dibutyl ether for the coating moiety and may comprise as well other components which impart various desirable properties to the coating solution and/or provide for the formation of an even layer of coating moiety.

Spin coating is a type of coating operation commonly used in he production of data storage discs. In the spin coating application of a dye layer to form the recording material on optical recording media, the factors governing formation of a suitably uniform dye layer are art-recognized, for example, those disclosed in U.S. Pat. Nos. 6,383,722 to Shinkai and 5,855,979 to Umehara. In general, an even dye layer is formed from an even application of the coating solution to the surface to be coated, and proper perturbation of the incipient dye layer during evaporation of the volatile constituents of the coating solution. Formation of an even layer of coating solution is generally accomplished by application of an excess of coating solution to the surface of the disc while it is spinning at an initial rate. The angular momentum distributes the coating solution across the disc, establishes an even layer of coating solution, and throws the excess solution off the disc. To maintain a uniform coating while the solvent evaporates, the rotation rate is typically increased in a series of steps as evaporation proceeds. At the appropriate time in the spin coating operation, the disc is usually exposed to an environment suitable to evaporate the liquid carrier of the coating solution.

The properties of the liquid constituents of a coating solution which carry, and preferably dissolve, the coating moiety (liquid carrier) can influence the uniformity of the finished coating. Applicants have come to appreciate that, in selecting a liquid carrier, factors to consider generally include: the amount of coating moiety which can be dissolved in the liquid carrier; the ability of a coating solution incorporating the liquid carrier to “wet” the surface to be coated; and the volatility of the liquid carrier, among others. Another factor to be considered in many applications is the tendency of any of the components of the liquid carrier to swell or locally dissolve the surface of the substrate to be coated. To achieve a uniform coating, it is generally required that no component of the coating solution causes swelling, degradation, or dissolution of the surface to be coated.

Applicants have also recognized that the liquid carrier should not be so volatile that the coating moiety precipitates from the coating solvent during storage or during formation of a coating solution layer on a surface to be coated. However, applicants recognize that the liquid carrier is also preferably sufficiently volatile that it can be removed in a short time after the coating solution has been distributed on the surface to be coated, minimizing the per-piece cycle time. The latter is generally also an important consideration in mass-production coating operations.

As has been shown in U.S. Pat. No. 6,383,722, (the 722 patent) the surface tension of the coating solution affects the volume of solution which must be applied to a surface to be coated to produce an even layer of coating solution on the surface. As the surface tension of the coating solution is reduced, it “wets” the surface to be coated increasingly well, requiring less of an excess of coating solution to be applied to the surface to ensure formation of a uniform coating solution layer. Accordingly, as less excess coating solution is needed, less solution is “spun off” and “wasted” during this part of the process. Additionally, for a given initial spinning rate, the lower surface tension coating solution spreads out over the surface to be coated more rapidly, which also reduces the per-piece cycle time of a coating operation.

Other considerations when applying a coating of a coating moiety to a surface include the ability of the coating solution to flow into and fill in patterned surface features, for example, “wells”, “pits”, and “grooves” provided in the surface, with coating moiety, thereby providing a “patterned” surface coating. An example of a patterned surface feature to be filled in by a coating moiety, described in the 722 patent, is a tracking groove on a writable CD.

Applicants have come to appreciate a need for a coating solution which at once has: a) relatively low surface tension (preferably on a variety of surfaces); b) and a relatively high solvent capacity for the desired coating moiety solute. Applicants have also come to appreciate a need for a coating solution which has a volatility that is sufficiently high to minimize the amount of time and volume of coating solution required to coat a surface while at the same time being sufficiently low to prevent instability of the solution.

A solvent typically used according to certain prior processes is dibutyl ether. Dibutyl ether, however, is flammable and has a high surface tension which makes it difficult to coat the dye smoothly. Other solvents such as those described in U.S. application Ser. No. 10/622,523, do not sufficiently “wet” the surface of a substrate and therefore require the use of a surface tension-reducing agent in addition to the solvent. The need for such an additional agent can be disadvantageous for several reasons, including cost and compatibility with the solvent and dye. Accordingly, applicants have come to recognize a need in the art for coating solutions that non-flammable and have a low surface tension, preferably without the need for a surface tension reducing agent, and are formed from components that are readily available.

### SUMMARY OF THE INVENTION

The above noted needs and others are preferably met by at least certain aspects of the present invention. One aspect of the present invention provides compositions comprising at least one coating moiety and a carrier which comprises, and preferably consists essentially of, at least one fluorinated alcohol solvent capable of providing high solubility and low surface tension, preferably even in the absence of a substantial amount of a separate surface tension reducing agent. In certain preferred embodiments, the at least one fluorinated alcohol has a surface tension of less than about 29 dynes/cm, more preferably less than about 25 dynes/cm, and even more preferably less than about 20 dynes/cm, as measured in general accordance with the procedures described in the examples hereof. It is also generally preferred in such embodiments that the at least one alcohol have a boiling point of not greater than about 100° C. It is also preferred in such embodiments that the at least one fluorinated alcohol have a DVD-R dye solubility of at least about 10 gm/100 ml, more preferably at least about 15 gm/100 ml, and even more preferably at least about 20 gm/100 m, where DVD-R dye solubility is measured as described in the example section hereof.

In certain preferred embodiments, the at least one fluorinated alcohol of the present invention has the structure R_{f}—OH, where: R_{f} is H—[CX₂]ₙ—; Z-[CX₂—CX₂]ₙ—; Z-[CZX—CX₂]ₙ—; Z-[CZX—CZX]ₙ—; CZ₂CH—; Z-[CX═CX]ₙ—; Z-[CZ═CX]ₙ—; Z-[CZ═CZ]ₙ—; Z-[CX₂]ₙ—; CX₂═CX—[CX₂]ₙ—; or Z-CZX—CX(CZX₂)—; Z is independently —CF₃, —CHF₂, —CH₂F; —R—CF₃, —R—CHF₂, or —R—CH₂F; R is a substituted or unsubstituted C₁-C₁₂ alkyl radical, or a substituted or unsubstituted fluorinated C₁-C₁₂ alkyl radical; X is independently hydrogen, Cl, Br, F, I, or Z; and n is an integer from 1 to 20, provided that the carbon attached to the OH is bound also to at least one H. In certain highly preferred embodiments, the fluorinated alcohol of the present invention has the structure R_{f}—OH, where: R_{f} is CZ₂CH— and Z is independently —CF₃, —CHF₂, —CH₂F, —C₂F₅ or —C₃F₇, with at least one Z being —CF₃, and even more preferably Z is independently —CF₃, —CHF₂, —CH₂F, with at least one Z being —CF₃.

As used herein, the term “coating moiety” is intended in its broad sense and can refer to any compound or mixture which remains on the surface of a coated object after completion of the coating process. The coating moiety which remains can be chemically bonded to the surface, for example, by a reaction with one or more surface species, or it may be adhered to the surface by, for example, electrostatic forces, as for a physisorbed layer. Examples of coating moieties which may be applied to a surface include a protective layer covering the surface to prevent mechanical damage to the surface and light reactive dye layers, for example, such as is deposited on a disk during the manufacture of a writable compact disk. A typical dye, for example, is metallic pthallocyanine.

In another aspect of the present invention, a method is provided for applying a coating moiety to a surface of a substrate comprising applying a composition comprising the coating moiety and at least one fluorinated alcohol solvent as previously defined.

### DETAILED DESCRIPTION OF PREFERRED EMBODIMENTS

It is contemplated that many varied types of substrates and substrate surfaces may have a coating applied thereto in accordance with the present invention, and methods and compositions for coating of all such substrates and surfaces are within the scope of the present invention. The compositions of the present invention preferably comprise at least the coating moiety and a carrier for the coating, with the carrier comprising at least one fluorinated alcohol as described herein. In certain preferred method aspects, the invention includes the steps of applying a composition of the present invention to a substrate to be coated to produce a coated substrate and then removing at least a portion of the carrier from the composition, preferably by evaporation, such that at least a portion of the coating moiety remains on the substrate, preferably as a film comprising the coating moiety. In certain preferred embodiments, the film that remains is a substantially uniform film that forms a substantially even coating on at least a portion of the surface. The materials which are removed from the substrate during processes of this type are sometimes referred to as “volatiles.”

For embodiments in which it is desired to provide an even coating by a solution coating process of the present invention, it is preferred that the coating moiety have an affinity for the surface to which it is applied. It is also preferred that the carrier has sufficient ability to solvate the coating moiety so that a substantially even layer can be formed during volatiles evaporation, thereby permitting the coating moiety layer to be deposited in a desired thickness. It will be appreciated that there are many techniques known in the art for carrying out a solution coating adaptable for use in accordance with the present invention. One example of solution coating which is well adapted for use in accordance with the present invention spin coating.

Preferred spin coating methods of the present invention comprise applying a coating solution of the present invention to a surface which has or is made to have an angular velocity, thereby preferably forming a relatively thin, substantially uniform layer of the coating solution on the surface, and evaporating at least one or more of the volatile components of the coating solution (volatiles) to leave behind a layer of a coating moiety on the surface.

For embodiments in which spin-coating is used to apply a layer of a coating moiety to a surface of a substrate for optically recording digital information (optical recording media), it is preferred that coating moiety comprise the light-reactive component of the recording media. Such a process can be used to deposit on the media, such as a data storage disc, a layer comprising the light-reactive dye on one face of a transparent disc. A suitable dye layer can be prepared by applying a solution comprising the dye (coating solution) to one face of the disc while it is spinning on an axis of rotation perpendicular to the face, thereby evenly distributing the coating solution. While spinning is continued, it is preferred to conduct the step of evaporating at least a portion, and preferably substantially all, of the volatile constituents of the coating solution, leaving behind a uniform dye layer adhered to the disc face.

Generally, in a spin-coating process, the initial rotational speed of the disc is selected to give the desired thickness of coating solution retained on the disc after application of coating solution. As the solvent evaporates, the timing and amount of angular velocity increase is determined by the thickness of the coating desired and the properties of the coating solution, for example, the concentration of the dye dissolved therein and the volatility of the liquid carrier.

It is known in the art, for example, U.S. Pat. No. 6,383,722 to Shinkai, that uniformity of the dye film provided by spin coating of dyes suitable for use in optical recording media is improved by the addition of an alkyl-alcohol, for example, methanol, ethanol, and propanol, to the liquid carrier used in formulating a coating solution. Applicants have come to recognize, however, that coating solutions which include such an alcohol constituent have low volatility and are only slowly converted to a dye film because the volatiles in the coating solution evaporate to an extent that is undesirably slow for many applications.

In one embodiment of the present invention, there is provided a coating solution formulation which demonstrates the same or better wetability on a surface to be coated, as compared to prior coating solutions, while at the same time having volatility characteristics as described above.

It will be appreciated that the coating solution of the present development may be used to apply a coating to a variety of surfaces for example, metal, plastic, and glass. In the above described example, the production of optical recording media, the surface to be coated is typically a thermoplastic resin, for example, polycarbonate, acrylic, amorphous polyolefin, polystyrene and the like, and coating solutions of the present development may be formulated which are suitable for applying a dye coating to those surfaces. It will be appreciated that, in the process of producing optical recording discs, additional layers, such as, for example, a reflecting layer and a protecting layer, may be added to produce a finished disc as is detailed in the publications referenced above.

In certain embodiments, the present invention includes methods of coating which comprise, for example, application of lubricant to a magnetic hard disc by dip coating and application by spin coating of a photo-active dye to a surface of an optically transparent disc in the production of optical storage media for storing digital information. Examples of optical storage media are commercially available DVD-R and CD-R data storage discs.

Coating solutions of the present development comprise a coating moiety dissolved in a coating solvent which comprises a miscible mixture of a fluorinated alcohol solvent and the coating moiety to be deposited on the substrate.

Certain of the preferred fluorinated alcohols of the present invention are generally represented by the formula R_{f}—OH, wherein Rf is selected from the group consisting of Z-[CZX—CX₂]ₙ; Z-[CZX—CZX]ₙ—; CZ₂CH—; Z-[CX═CX]—; Z-[CZ═CX]ₙ—; Z-[CZ═CZ]ₙ—; CX₂═CX—[CX₂]ₙ—; and Z-CZX—CX(CZX₂)—, wherein Z is independently —CF₃, —CHF₂, —CH₂F; —R—CF₃, —R—CHF₂, or —R—CH₂F, wherein R is a substituted or unsubstituted C₁-C₁₂ alkyl radical (straight chained or branched), or a substituted or unsubstituted fluorinated C₁-C₁₂ alkyl radical (straight chained or branched); X is independently hydrogen, Cl, Br, F, I, or Z; and n is an integer from 1 to 20.

Preferably, the fluorinated alcohols of the present invention have at least one terminal group, Z, selected from the group consisting of—CF₃, —CHF₂, —R—CF₃, and —R—CHF₂. More preferably, the fluorinated alcohols of the present invention have at least one terminal group, Z, selected from the group consisting of —CF₃ and —R—CF₃.

R may be, for example, a fluorinated or non-fluorinated methyl, ethyl, n-propyl, isopropyl, n-butyl, isobutyl, tert-butyl, n-pentyl, neopentyl, n-hexyl, n-heptyl, n-octyl or 2-ethylhexyl. Any of these groups may be substituted with essentially any conventional organic moiety, for example, methoxy, ethoxy, n-propoxy, isopropoxy, n-butoxy, methanesulphonyl, cyano, bromine or chlorine. The substituents, if any, are preferably attached to non-fluorinated carbon atoms of R.

In certain preferred embodiments, X is hydrogen.

In certain preferred embodiments of the present invention, n is 1 to 4. In more preferred embodiments, n is 1 to 3, and even more preferably 1 or 2.

Preferred fluorinated alcohols according to the invention include, for example, CF₃CH₂CF₂CH₂OH, CF₃CH₂CFHCH₂OH, CF₃CFHCH₂CH₂OH, CF₃CH₂CBrCH₂OH, CF₃CH₂CH₂CH₂OH, (CF₃)₂CHOH, (CF₃)₂CF—CFH—C(CF₃)F—CH₂OH, (CF₃)₂CF—CF(CH₂OH)C(CF₃)FH, HOCH₂(CF₂)ₙCH₂OH, CF₃(CF₂)ₙCH₂OH, CF₃(CF₂)ₙCH₂CH₂OH, H—[ClCF—CF_{2—}]ₙCH₂OH, where n is an integer from 1-4. The at least one fluorinated alcohol of the present invention may be combined with other solvents, including but not limited to any one or more of the other fluorinated alcohols of the present invention. The amount and type of such combination will depend on several factors affecting the desired use and can be readily determined by those skilled in the art in view of the teachings contained herein. In certain preferred embodiment the carrier liquid comprised at least on fluorinated alcohol according to the present invention and tetrafluorpropanol, which has a boiling point of about 109° C., a surface tension of about 29 dynes/cm and a DVD-R dye solubility of about 11 g/100 ml.

In certain preferred embodiments the fluorinated alcohols have the formula CF₃(CX₂)ₙ—CH₂OH, where X is as defined above. As can be seen, in these preferred embodiments the carbon attached to the —OH is bound to one carbon and two hydrogens, and the terminal portion of the molecule opposite the —OH comprises CF₃.

The coating solution of the present invention may include a mixture of more two or more fluorinated alcohols represented by the formula R_{f}—OH, wherein R_{f} is as previously defined.

The coating solutions of the present invention typically include between about 50% to about 99.5% by weight of at least one compound having the formula R_{f}—OH. Preferably, the coating solutions of the present invention typically include between about 80% to about 99% by weight of at least one compound having the formula R_{f}—OH. More preferably, the coating solutions of the present invention comprise from about 75% to about 99.9% by weight, more preferably about 90% to about 99.9% by weight, and even more preferably from about 95% to about 99.9% by weight of at least one compound having the formula R_{f}—OH. In certain coating applications, for example in certain spin coating applications, the coating solutions of the present invention preferably comprise from about 97% to about 99.9% by weight of at least one compound having the formula R_{f}—OH.

The fluorinated alcohols of the present invention are known in the art or can be prepared by art procedures that are known to those skilled in the art. For example, Hazledine et. al, J. Fluorine Chem. 1985, 28, 291-302 describes the preparation of CF₃CFHCF₂CH₂OH from CF₃CF═CF₂ and methanol. Fluorinated alcohols according to formula R_{f}—OH including, for example, CF₃CH₂CF₂CH₂OH, CF₃CH₂CFHCH₂OH, CF₃CFHCH₂CH₂OH, CF₃CH₂CBrCH₂OH, CF₃CH₂CH₂CH₂OH can be prepared according to procedures reported in the U.S. Pat. No. 6,673,976 B1.

Fluorinated alcohols according to formula R_{f}—OH wherein R_{f} is selected from the group consisting of Z-[CX₂—CX₂]ₙ—; Z-[CZX—CX₂]ₙ—; and Z-[CZX—CZX]ₙ can be prepared from CF₂═CFCl and methanol as described in U.S. Pat. No. 6,291,704 B1 (see Example 12). Reaction of hexafluoropropene dimmer, (CF₃)₂CF—CF═CF(CF₃), and CH₃OH under photochemical conditions affords (CF₃)₂CF—CFH—C(CF₃)F—CH₂OH (isomers). Many fluorinated alcohols such as, for example, CF₃(CF₂)ₙCH₂OH, CF₃(CF₂)ₙCH₂CH₂OH, HOCH₂(CF₂)ₙCH₂OH (n═1, 2, 3 . . . ) and the like are commercially available from, for example Synquest Laboratories Inc., of Alachua, Fla.

Coating moieties suitable for use in coating solutions of the present invention are selected from chemical species which exhibit an affinity, whether by chemisorption or physisorption, for the surface to be coated, are soluble to a level of at least some measurable degree in the surface tension-reducing fluorinated alcohol(s) according to formula R_{f}—OH selected for the formulation, and are soluble to at least about 0.1 wt. % in a mixture comprising the fluorinated alcohol, thereby permitting suitable concentrations of the coating moiety to be dissolved in the fluorinated alcohol.

Although coating moieties suitable for use in coating solutions of the present invention can be found that pertain to a wide range of coating applications, the present invention is particularly direct to a coating solution for the provision of a light-reactive dye layer in optical recording media, as mentioned above. Fluorinated alcohols according to the invention typically exhibit good solubility for a variety of such dyes. An example of a class of suitable light reactive dyes used in optical recording media is the cyanine dyes such as, for example, SO628 from Organica. Although it is contemplated that various and numerous types of dyes are adaptable for use in accordance with the present invention, especially beneficial results can be obtained in connection with dyes of the type used in connection with coating of optical recording media, such as DVD-R dyes including cyanine, azo metal chelates, and dipyrromethene metal chelate-based dyes. One cyanine dye has the structure shown in Structure 1 below.

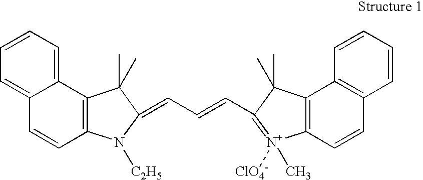

Other examples of cyanine dyes include SO 611, SO 627 and SO 628 obtained from FEW Chemicals. Still other examples of dyes suitable for use in optical recording media in accordance with this invention include rhodamine dyes, phthalacyanine dyes, formazan dyes, triphenylmethane dyes, azo dyes, and azo metal dyes. Specific examples of these and still other suitable dyes are known to those skilled in the art and are described in, for example, U.S. Pat. Nos. 6,383,722 to Shinkai, 5,855,979 to Vomehara, and 5,693,396 to Misawa, each of which is incorporated herein by reference. Cyanine dyes are preferred in coating solutions of the present invention when the solutions are used in the formation of a light-reactive dye layer in optical recording media.

The coating moiety of a coating solution of the present invention can comprise for example, one of the dyes described above, or a mixture of one or more dyes. Coating solutions may also optionally include additional constituents, for example, a light stabilizer, for example, IRG 022 quencher from HBL (Japan), a binder, a thermal decomposition promoter, a dispersant, and other constituents as are known in the art. Preferably, the concentration of dye used in a coating solution according to the invention is from about 0.1 to about 20%, more preferably from about 0.1 to about 10%, and even more preferably from about 0.1 to about 5% by weight. Other ratios may be employed, as are warranted by the solubility, coating, parameters, and requirements of the coating to be applied.

The coating solution of the present invention is made by dissolving the coating moiety in a coating solvent. The additional constituents as described above, if included, are also dissolved in the solvent. Although coating moieties suitable for use in coating solutions of the present invention can be found which pertain to a wide range of coating applications, examples are given below of those suitable for providing a light-reactive dye layer, the active recording material in optical recording media, as mentioned above.

Thus, with regard to a coating solution for the provision of a light-reactive dye layer in optical storage media wherein the coating solution comprises as a coating moiety one or more light reactive dyes that are dissolved in a coating solvent comprising a fluorinated alcohol solvent according to the invention, the resultant coating solution has a low surface tension without the need for additional surface tension-lowering components.

The coating solutions of the present invention may be prepared by any known means of blending a volatile material. Conveniently, a coating solution can be prepared by combining a weighted amount of coating moiety, for example, a dye material and a stabilizer material, and a measured volume of a solvent, for example, a fluorinated alcohol according to the invention, in a vessel with stirring until the solid components have dissolved.

A coating solution of the present invention can be utilized in coating methods such as, for example, spin coating methods. Spin coating methods, for example, typically employ an apparatus that conveys the coating solution by pumping, spraying, or gravity flow.

In another embodiment of the present invention, a method is provided for applying a coating moiety to a surface of a substrate comprising applying a coating solution consisting essentially of a fluorinated alcohol solvent and a coating moiety. In a preferred embodiment, the fluorinated alcohol solvent includes at least one fluorinated alcohol that has a structure R_{f}—OH, wherein R_{f} is selected from the group consisting of H—[CX₂]ₙ—; Z-[CX₂—CX₂]ₙ—; Z-[CZX—CX₂]ₙ—; Z-[CZX—CZX]ₙ—; CZ₂CH—; Z-[CX═CX]ₙ—; Z-[CZ═CX]ₙ—; Z-[CZ═CZ]ₙ—; Z-[CX₂]ₙ—; CX₂═CX—[CX₂]ₙ—; and Z-CZX—CX(CZX₂)—, wherein Z is —CF₃, —CHF₂, —CH₂F; —R—CF₃, —R—CHF₂, or —R—CH₂F, wherein R is a substituted or unsubstituted C₁-C₁₂ alkyl radical, or a substituted or unsubstituted fluorinated C₁-C₁₂ alkyl radical; X is hydrogen, Cl, Br, F, I, or Z; and n is an integer from 1 to 20.

The following examples are presented for the purpose of illustrating the forgoing description and are not meant to limit the scope of the claimed invention.

### EXAMPLES

### Example 1

### Synthesis of (CF₃)₂CF—CFH—C(CF₃)F—CH₂OH and (CF₃)₂CF—CF(CH₂OH)—C(CF₃)FH (reaction of hexafluorpropene dimer with methanol)

a) Photochemical reaction at 254 nm

In a quartz tube (500 mL capacity) equipped with water condenser and magnetic stir bar, anhydrous methanol (96 g, 3.0 mol), ditert-butylperoxide (4.74 g, 0.032 mol) and (CF₃)₂CF—CF═CF(CF₃) (130 g, 0.43 mol) were added under nitrogen. The reaction mixture was stirred and irradiated (at 254 nm, 8 lamps of 4 watt each) in a Rayonet Photochemical Reactor [Rayonet Photochemical, Inc., Branford, Conn.] overnight (˜5 h). The (CF₃)₂CF—CF═CF(CF₃) component formed a separate layer, which gradually disappeared as the reaction progressed; a one-phase homogeneous solution resulted on completion. Excess methanol was removed under reduced pressure and the residue was stirred for 5 min with 100 mL 10% aq. Na₂SO₃ solution. The lower layer was separated, washed with 100 mL water, dried (Na₂SO₄), and distilled (45-55° C./90 mm Hg) via a short path Vigreux column to yield 92 g (yield═72%; GC purity>95%) (CF₃)₂CF—CFH—C(CF₃)(F)—CH₂OH and (CF₃)₂CF—CF(CH₂OH)—C(CF₃)FH in the weight ratio of about 1:1. GC/MS (Cl/CH₄); m/e at 333 for (M+1)⁺ (M═C₇H₄F₁₂O) for both isomers; NMR (¹⁹F, ¹H) spectral data are consistent with the structures.

b) Photochemical reaction with broad spectrum (200-400 nm) medium pressure Hg lamp

Anhydrous methanol (316 g, 9.87 mol), ditert-butylperoxide (27.9 g, 0.14 mol) and (CF₃)₂CF—CF═CF(CF₃) (378 g, 1.26 mol) were added under nitrogen into a jacketed Ace photochemical reactor (˜1 L capacity) equipped with a −10° C. condenser, a quartz immersion well, a nitrogen tee, and a magnetic stir-bar. The two-phase reaction mixture was irradiated with a 100-watt lamp with vigorous mixing for 24 h at 15-17° C. GC analysis indicated an approximate 50% conversion of the HFP-dimer to the desired alcohol. The 100-watt lamp was replaced by 450-watt lamp and irradiated for additional 6 h and a one-phase solution resulted. GC analysis indicated that the reaction had proceeded to completion. The product was separated and purified in a similar fashion as described above in part a). The percent yield was 50% (213 g).

### Example 2

### Solubility of Dyes in Fluoroalcohols Having Varying Surface Tensions

Cyanine dye, and in particular the cyanine dye sold at about the time of filing of the present application by FEW Chemicals under the trade designation SO628, was dissolved in various fluorinated alcohols as shown in Table 1. Preferred compositions comprised from about 1 to about 23 wt. % of the dye. Solubility was determined by adding dye powder slowly to a weighed 100 ml aliquot of the fluorinated solvent in a vessel. The solvent was stirred to dissolve the dye. When no more dye would dissolve, the dye addition was stopped and the solvent reweighed to determine the amount of dye that had been dissolved in the solvent.

The surface tension of the fluorinated alcohols according to the present invention was also measured and reported in Table 1. The measurements were made using the Nouy ring method and a Kruss Instrument Model K 10 ST. In a typical determination, a 20 ml aliquot of the fluorinated alcohol was placed in the instrument and the surface tension was measured according to the recommended procedure for the Kruss Instrument Model K 10 ST. The surface tension exhibited by the coating solutions under the test conditions described above are presented below in Table 1.

The data in Table 1 (below) shows that the fluorinated alcohols of entry No. 1 appears to offer better solubility for the DVD-R dye and having a preferred boiling point of less than about 100° C. and a low surface tension value. The surface tension of the non-fluorinated analog of 1 (isopropyl alcohol) is 21.7 dynes cm⁻¹.

TABLE I
DVD-R Dye Solubility and Surface Tension of Selected Alcohols

| | | | | Solubility of |
|---|---|---|---|---|
| | | | Surface | DVD-R dye |
| | | Temperature | Tension | Wt % |
| No | Alcohol | ° C | Dynes cm⁻¹ | (g/100 mL) |
| 1 | (CF₃)₂CH—OH | 22.5 | 18.5 | 22 |
| 2 | CF₃CH₂CF₂CH₂OH | 21.8 | 27.0 | 7.0 |
| 3 | CF₃CF₂CH₂OH | 21.9 | 19.7 | 5.0 |
| 4 | HCF₂(CF₂)₅CH₂OH | 22.1 | 25.8 | 1.5 |
| 5 | CF₃(CF₂)₅CH₂CH₂OH | 22.3 | 20 | 1.0 |
| 6 | CF₃CH₂CF₂CH₂OH + | 22 | NA | 15 |
| | (CF₃)₂CH—OH | | | |
| | (95:5 wt %) | | | |

The foregoing examples and description of the preferred embodiment should be taken as illustrating, rather than as limiting, the present invention as defined by the claims. As will be readily appreciated, numerous variations and combinations of the features set forth above can be utilized without departing from the present invention as set forth in the claims. Such variations are not regarded as a departure from the spirit and scope of the invention, and all such variations are intended to be included within the scope of the following claims.

What is claimed is:

1. An ink for recordable media comprising at least one coating moiety and at least one fluorinated alcohol solvent for said coating moiety, said at least one fluorinated alcohol having a surface tension of not greater than about 27 dynes/cm.

2. The ink of claim 1 wherein the fluorinated alcohol solvent comprises at least one fluorinated alcohol having the structure R_{f}—OH, where:
R_{f} is H—[CX₂]ₙ—; Z-[CX₂-CX₂]ₙ—; Z-[CZX—CX₂]ₙ—; Z-[CZX—CZX]ₙ—; CZ₂CH—; Z-[CX═CX]ₙ—; Z-[CZ═CX]ₙ—; Z-[CZ═CZ]ₙ—; Z-[CX₂]ₙ—; CX₂═CX—[CX₂]ₙ—; and Z-CZX—CX(CZX₂)—,
Z is independently —CF₃, —CHF₂, —CH₂F; —R—CF₃, —R—CHF₂, or —R—CH₂F,
R is a substituted or unsubstituted C₁-C₁₂ alkyl radical, or a substituted or unsubstituted fluorinated C₁-C₁₂ alkyl radical,
X is independently hydrogen, Cl, Br, F, I, or Z; and
n is an integer from 1 to 20, provided that the carbon attached to the OH is bound also to at least one H.

3. The ink of claim 2 wherein at least one Z is —CF₃.

4. The ink of claim 3 wherein at least one X is F.

5. The ink of claim 4 wherein n is an integer from 1 to 4.

6. The ink of claim 5 wherein n is an integer from 1 to 3.

7. The ink of claim 6 wherein n is 1 or 2.

8. The ink of claim 1 wherein the coating moiety comprises a dye.

9. The ink of claim 8 wherein said dye comprises at least one cyanine dye.

10. The ink of claim 1 wherein said at least one fluoroalcohol has a surface tension of not greater than about 20 dynes/cm.

11. The ink of claim 1 wherein said at least one fluoroalcohol has the structure R_{f}—OH, where: R_{f} is CZ₂CH— and Z is independently —CF₃, —CHF₂, —CH₂F, with at least one Z being —CF₃.

12. The ink of claim 1 further comprising tetrafluorpropanol.

13. The ink of claim 1 wherein said at least one fluoroalcohol has the formula CF₃(CX₂)ₙ—CH₂OH.

14. The ink of claim 1 wherein said at least one fluoroalcohol comprises a combination of two or more fluoroalcohols.

15. A method of applying a coating moiety to a surface of a substrate comprising:
applying coating solution consisting essentially of a fluorinated alcohol solvent and the coating moiety.

16. The method of claim 15 wherein the fluorinated alcohol solvent comprises at least one fluorinated alcohol having the structure R_{f}—OH, wherein R_{f} is selected from the group consisting of H—[CX₂]ₙ—; Z-[CX₂—CX₂]ₙ—; Z-[CZX—CX₂]ₙ—; Z-[CZX—CZX]ₙ—; CZ₂CH—; Z-[CX═CX]ₙ—; Z-[CZ═CX]ₙ—; Z-[CZ═CZ]ₙ—; Z-[CX₂]ₙ—; CX₂═CX—[CX₂]ₙ; and Z-CZX—CX(CZX₂)—,
wherein
Z is independently —CF₃, —CHF₂, —CH₂F; —R—CF₃, —R—CHF₂, or —R—CH₂F, wherein R is a substituted or unsubstituted C₁-C₁₂ alkyl radical, or a substituted or unsubstituted fluorinated C₁-C₁₂ alkyl radical;
X is independently hydrogen, Cl, Br, F, I, or Z; and
n is an integer from 1 to 20.

17. The method of claim 16 wherein at least one Z is —CF₃.

18. The method of claim 17 where said coating moiety comprises a dye.

19. The method of claim 17 where said coating moiety comprises a lubricant.

20. The method of claim 17 where the substrate comprises an optical recording medium.

21. The method of claim 20 where said optical recording medium is a digital video disk.

22. The method of claim 17, wherein said coating is formed from a coating solution applied to said substrate surface by spin coating.

23. The method of claim 17, wherein said coating is formed from a coating solution applied to said substrate surface by dip coating.

24. The method of claim 17 further comprising the step of removing the fluorinated alcohol from the surface of the substrate.

25. The method of claim 15 wherein the coating solution is an ink.

26. The method of claim 15 wherein the fluorinated alcohol is (CF₃)₂CH—OH.

27. An ink for recordable media comprising at least one coating moiety and at least one fluorinated alcohol solvent for said coating moiety, said at least one fluorinated alcohol having a surface tension of not greater than about 27 dynes/cm and a DVD-R dye solubility of at least about 10 gm/100 ml.

28. The ink of claim 27 wherein said at least one fluorinated alcohol has a surface tension of not greater than about 25 dynes/cm and a DVD-R dye solubility of at least about 15 gm/100 ml.

29. The ink of claim 27 wherein said at least one fluorinated alcohol has a surface tension of not greater than about 20 dynes/cm and a DVD-R dye solubility of at least about 20 gm/100 ml.

30. The ink of claim 29 wherein said at least one fluorinated alcohol has a boiling point of not greater than about 100° C.

31. The ink of claim 30 wherein said at least one fluorinated alcohol has a boiling point of not greater than about 100° C.
